(19) United States
(12) Patent Application Publication
(10) Pub. No.: US 2026/0312339 A1
(43) Pub. Date: Oct. 8, 2026

(54) CONNECTOR

(71) Applicant: Molex, LLC, Lisle, IL (US)

(72) Inventors: Jhen Lin Tan, Jurong Town (SG); Ming Hao Chou, New Taipei (TW)

(21) Appl. No.: 19/455,935

(22) Filed: Jan. 22, 2026

(30) Foreign Application Priority Data
Jan. 24, 2025 (TW) 114103383
Jan. 9, 2026 (TW) 115100984

(51) Int. Cl. H01R 13/6587; H01R 12/73

(52) U.S. Cl. CPC H01R 13/6587; H01R 12/737

(57) ABSTRACT

A connector includes a terminal module, a grounding conductor and a shielding assembly. The terminal module includes an insulative terminal base and a plurality of signal terminal pairs provided to the insulative terminal base. The grounding conductor is provided to a front portion of the insulative terminal base of the terminal module, the grounding conductor has a plurality of passageways which is penetratingly formed front and rear and respectively correspond to the plurality of signal terminal pairs. The shielding assembly is provided to the grounding conductor, the shielding assembly includes a plurality of shielding structures which correspond to the plurality of signal terminal pairs, each shielding structure includes a basic plate and two side plates which are provided to a front portion of the grounding conductor, and a mating slot which is defined together by the basic plate and the two side plates, the mating slot is positioned in front of the corresponding passageway and is communicated with the passageway, each signal terminal pair forwardly passes through the corresponding passageway without contacting the grounding conductor, to extend into the mating slot, each side plate has a ground elastic piece which protrudes toward the mating slot.

### TECHNICAL FIELD

The present disclosure relates to a connector, and particularly relates to a connector which has a shielding assembly.

### BACKGROUND

Recently, high-speed connectors are applied in devices, such as servers and the like. As transmission speed of the connector becomes faster and faster, crosstalk between terminals also become more and more difficult to overcome, which makes signal integrity poor. Therefore, corresponding to the high-speed connector with the high transmission speed, it needs to research and develop a more complete shielding solution to lower crosstalk so as to maintain signal integrity of the connector.

### SUMMARY

Therefore, an object of the present disclosure is to provide a connector which can improve at least one problem in the background.

Accordingly, in some implementing manners, a connector of the present disclosure comprises a terminal module, a grounding conductor and a shielding assembly. The terminal module comprises an insulative terminal base and a plurality of signal terminal pairs provided to the insulative terminal base. The grounding conductor is provided to a front portion of the insulative terminal base of the terminal module, the grounding conductor has a plurality of passageways which is penetratingly formed front and rear and respectively correspond to the plurality of signal terminal pairs. The shielding assembly is provided to the grounding conductor, the shielding assembly comprises a plurality of shielding structures which correspond to the plurality of signal terminal pairs, each shielding structure comprises a basic plate and two side plates which are provided to a front portion of the grounding conductor, and a mating slot which is defined together by the basic plate and the two side plates, the mating slot is positioned in front of the corresponding passageway and is communicated with the passageway, each signal terminal pair forwardly passes through the corresponding passageway without contacting the grounding conductor, to extend into the mating slot, each side plate has a ground elastic piece which protrudes toward the mating slot.

In some implementing manners, a material of the grounding conductor is a conductive plastic.

In some implementing manners, each side plate has the two ground elastic pieces which are arranged front and rear.

In some implementing manners, each signal terminal pair of the terminal module has two signal terminals, each signal terminal has a passing portion which passes through the passageway, a contacting portion which is used for mating, and a wide enlarged portion which is positioned between the passing portion and the contacting portion and has a width larger than the contacting portion.

Accordingly, in some implementing manners, a connector of the present disclosure comprises a shielding assembly and a terminal module. The shielding assembly comprises a shielding structure row, the shielding structure row comprises a ground shielding plate, multiple partitioning plate components which are spaced apart from each other and arranged side by side and are provided to the ground shielding plate, and multiple mating slots which are defined together by the ground shielding plate and the multiple partitioning plate components. The terminal module comprises a plurality of signal terminal pairs, the plurality of signal terminal pairs correspondingly extend into the multiple mating slots.

In some implementing manners, each partitioning plate component has two partitioning plates which are spaced apart from each other and arranged side by side, each partitioning plate has a ground elastic piece which protrudes toward the adjacent mating slot.

In some implementing manners, each partitioning plate further has a first plate portion and a second plate portion which is bent from and connected to the first plate portion and is away from the adjacent mating slot relative to the first plate portion, the first plate portion has an opening and the ground elastic piece which is formed at an edge of the opening, the second plate portion blocks the opening of the first plate portion.

In some implementing manners, the ground shielding plate has a shielding plate body which allows the multiple partitioning plate components to be provided thereon, and two side plate bodies which bend from two side edges of the shielding plate body respectively and extend, and are spaced apart from and arranged side by side with the multiple partitioning plate components, each side plate body has a ground elastic piece which protrudes toward the adjacent mating slot.

In some implementing manners, the shielding assembly comprises the plurality of shielding structure rows which are staggeringly arranged side by side, the ground shielding plate of each shielding structure row further has a contact plate body which bends from one of the two side plate bodies and extends outwardly, the contact plate body has a contact elastic piece which contacts the shielding plate body of the ground shielding plate of the adjacent shielding structure row.

In some implementing manners, the terminal module further comprises an insulative terminal base, the plurality of signal terminal pairs are provided to the insulative terminal base, the connector further comprises a grounding conductor, the grounding conductor is provided to a front portion of the insulative terminal base of the terminal module, and the shielding assembly is provided to a front portion of the grounding conductor, the grounding conductor has a plurality of passageways which is penetratingly formed front and rear and respectively correspond to the plurality of signal terminal pairs, each signal terminal pair forwardly passes through the corresponding passageway without contacting the grounding conductor, to extend into the mating slot.

In some implementing manners, each signal terminal pair of the terminal module has two signal terminals, each signal terminal has a passing portion which passes through the passageway, a contacting portion which is used for mating, and a wide enlarged portion which is positioned between the passing portion and the contacting portion and has a width larger than the contacting portion.

In some implementing manners, the terminal module further comprises an insulative terminal base and a plurality of terminal shielding structures, the plurality of signal terminal pairs are provided to the insulative terminal base, the plurality of terminal shielding structures respectively correspond to the plurality of signal terminal pairs, each terminal shielding structure has a basic wall and side walls which extend from the basic wall, each terminal shielding structure at least locally forms a U-shaped shielding structure which is constituted together by the basic wall and the side walls and receives the corresponding signal terminal pair.

In some implementing manners, the terminal module further comprises a plurality of terminal shielding members, the plurality of signal terminal pairs are arranged as rows and are provided to the insulative terminal base, the plurality of terminal shielding members are provided to the insulative terminal base and respectively correspond to the plurality of signal terminal pairs arranged as the rows, each terminal shielding member comprises a shielding plate and a shielding frame which is provided to the shielding plate and is formed with the terminal shielding structures.

In some implementing manners, the shielding assembly includes the plurality of shielding structure rows which are arranged side by side, the multiple partitioning plate components of each shielding structure row are further connected to the ground shielding plate of the adjacent shielding structure row, so that the two adjacent ground shielding plates are connected in series.

In some implementing manners, the ground shielding plate of each shielding structure row has a multitude of first providing holes and a multitude of second providing holes, each partitioning plate component has a first providing protrusion which is used to be provided in the corresponding first providing hole of the ground shielding plate, and a second providing protrusion which is used to be provided in the corresponding second providing hole of the ground shielding plate of the adjacent shielding structure row.

In some implementing manners, the shielding structure row further includes two side partitioning plate components which are respectively provided to two side portions of the ground shielding plate and are spaced apart from and arranged side by side with the multiple partitioning plate components, each side partitioning plate component has a ground elastic piece which protrudes toward the adjacent mating slot.

In some implementing manners, each side partitioning plate component has a side plate, the side plate has a first plate portion and a second plate portion which is bent from and connected to the first plate portion and is away from the adjacent mating slot relative to the first plate portion, the first plate portion has an opening and the ground elastic piece which is formed at an edge of the opening, the second plate portion blocks the opening of the first plate portion.

In some implementing manners, each partitioning plate component has two partitioning plates which are spaced apart from each other and arranged side by side, each partitioning plate has a ground elastic piece which protrudes toward the adjacent mating slot; each side partitioning plate component has a side plate, the side plate has the ground elastic piece which protrudes toward the adjacent mating slot.

In some implementing manners, the shielding assembly includes the plurality of shielding structure rows which are arranged side by side, the two side partitioning plate components of each shielding structure row are further connected to the ground shielding plate of the adjacent shielding structure row, so that the two adjacent ground shielding plates are connected in series.

In some implementing manners, the ground shielding plate of each shielding structure row has a multitude of first providing holes and a multitude of second providing holes, each side partitioning plate component has a first providing protrusion which is used to be provided in the corresponding first providing hole of the ground shielding plate, and a second providing protrusion which is used to be provided in the corresponding second providing hole of the ground shielding plate of the adjacent shielding structure row.

In the connector of the present disclosure, the grounding conductor and the multiple shielding structures of the shielding assembly provided to the grounding conductor can shelter the respective signal terminal pairs; in addition, the ground shielding plate of the shielding assembly and the multiple partitioning plate components can together define the multiple mating slots which receive the respective signal terminal pairs, because the multiple mating slots are defined by the same the ground shielding plate, each mating slot can attain good equipotential effect in ground shielding. Thus, complete shielding effect is attained to lower crosstalk so as to maintain signal integrity of the connector.

### BRIEF DESCRIPTION OF THE DRAWINGS

Other features and effects of the present disclosure will become more apparent from implementing manners with reference to the drawings, in which:

FIG. 1 is a perspective view of a first embodiment of a connector of the present disclosure and a counterpart connector;

FIG. 2 is a perspective view of the first embodiment and the counterpart connector viewed from another angle;

FIG. 3 is a perspective exploded view of FIG. 1;

FIG. 4 is a perspective exploded view of FIG. 2;

FIG. 5 is a perspective exploded view based on FIG. 4 with a housing of the first embodiment omitted;

FIG. 6 is a partially enlarged perspective view based on FIG. 5 and illustrating a grounding conductor and a shielding assembly of the first embodiment;

FIG. 7 is a perspective exploded view of the first embodiment;

FIG. 8 is a perspective exploded view of the first embodiment viewed from another angle with the housing of the first embodiment omitted;

FIG. 9 is a side view of the first embodiment and the counterpart connector;

FIG. 10 is a cross-sectional view taken along a line A-A of FIG. 9;

FIG. 11 is a partially enlarged perspective view of a second embodiment of the connector of the present disclosure which is used to describe the shielding assembly of the second embodiment with a terminal module of the second embodiment partially omitted;

FIG. 12 is a partially enlarged perspective view similar to FIG. 11 and viewed from a different angle; and

FIG. 13 is a partially enlarged perspective exploded view based on FIG. 11.

### DETAILED DESCRIPTION

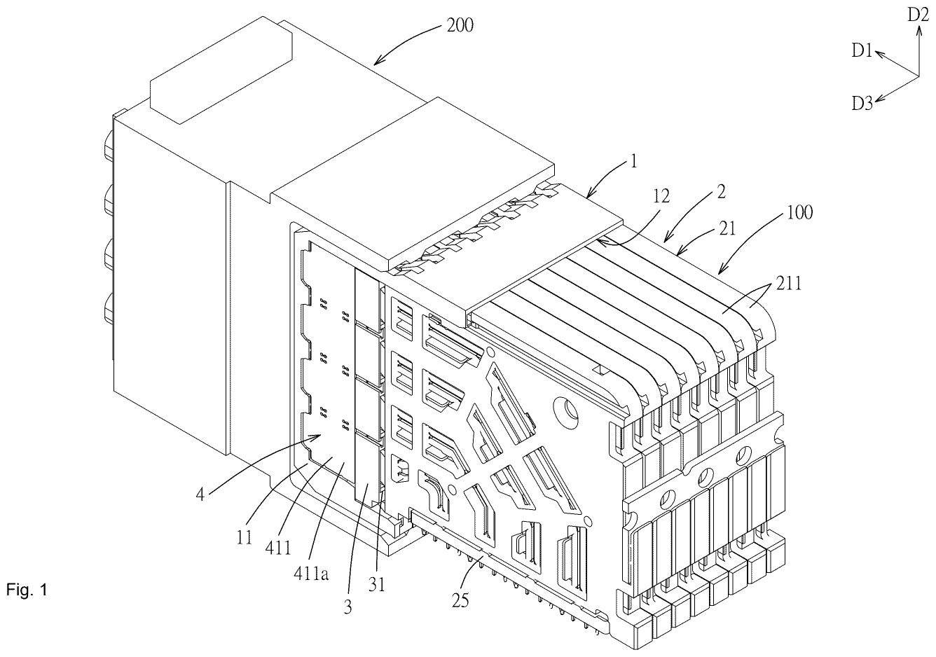

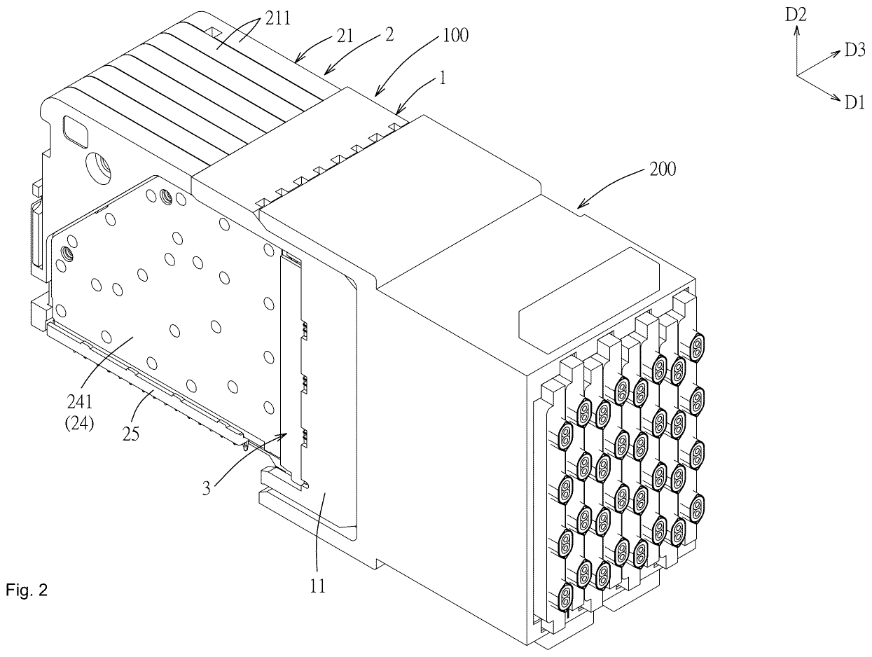

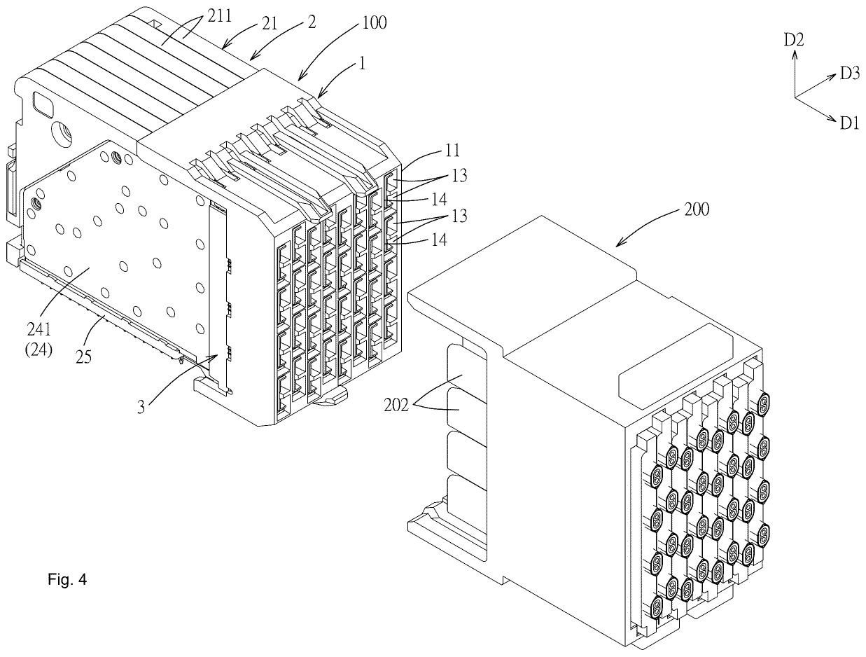

Referring to FIG. 1 to FIG. 4, a first embodiment of a connector 100 of the present disclosure is adapted to mate with a counterpart connector 200, the connector 100 includes a housing 1, a terminal module 2, a grounding conductor 3, and a shielding assembly 4.

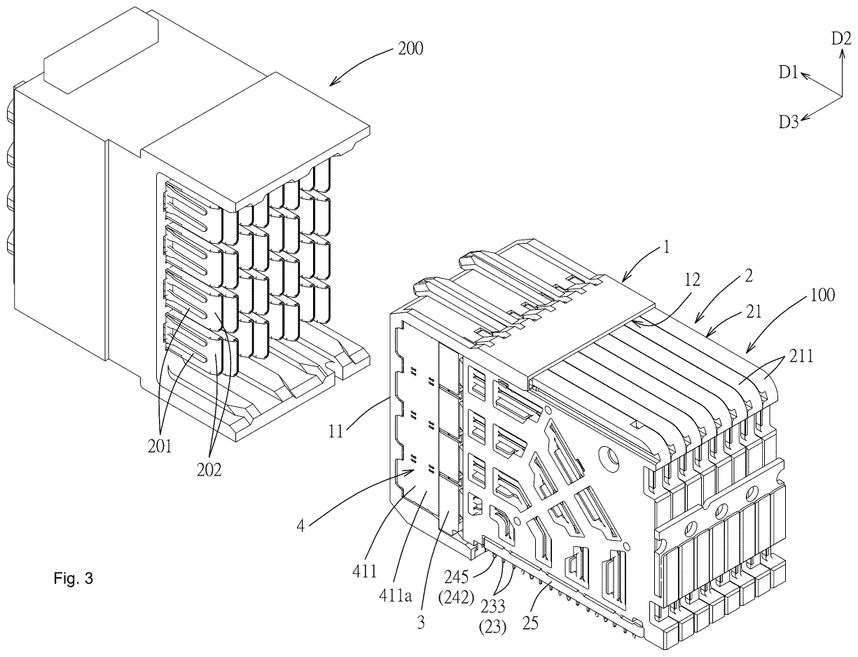

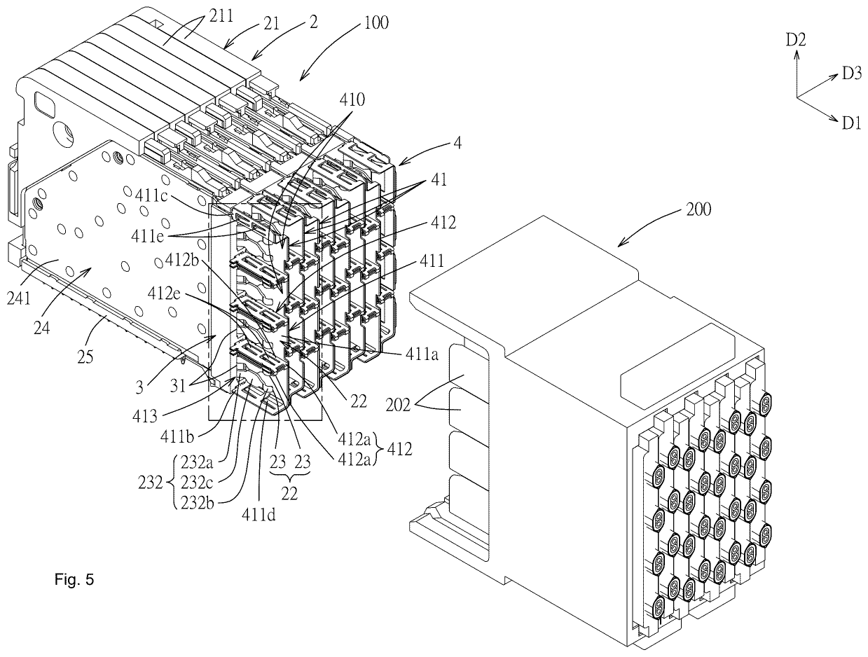

Referring to FIG. 3 to FIG. 5, the housing 1 has a mating portion 11 which is toward the front in a front-rear direction D1 (an arrow points to front and an opposite direction points to rear), an assembling groove 12 which is opened toward the rear, a plurality of signal mating ports 13 which are formed to the mating portion 11, and a plurality of ground mating ports 14 which are formed to the mating portion 11 and which each have a U-shaped cross section. The plurality of signal mating ports 13 and the plurality of ground mating ports 14 are respectively arranged as rows which each are along an up-down direction D2 (an arrow points to up and an opposite direction points to down), and the rows of the signal mating ports 13 and the rows of the ground mating ports 14 are respectively arranged along a left-right direction D3 (an arrow points to right and an opposite direction points to left).

The terminal module 2 is assembled to a rear portion of the assembling groove 12 of the housing 1. The terminal module 2 includes an insulative terminal base 21, a plurality of signal terminal pairs 22 which are provided to the insulative terminal base 21, a plurality of terminal shielding members 24 which are provided to the insulative terminal base 21, and an insulative bottom base 25 which is provided to a bottom of the insulative terminal base 21. The insulative terminal base 21 includes a plurality of terminal base wafers 211 which are arranged and assembled along the left-right direction D3. The plurality of signal terminal pairs 22 are arranged as rows which each are along the up-down direction D2, and the rows of the signal terminal pairs 22 are arranged side by side along the left-right direction D3 and are respectively provided to the plurality of terminal base wafers 211 of the insulative terminal base 21. Specifically, the plurality of signal terminal pairs 22 may be correspondingly provided to the plurality of terminal base wafers 211 of the insulative terminal base 21 by insert molding and the like with each signal terminal pair 22 at least locally cladded, but the present disclosure is not limited thereto.

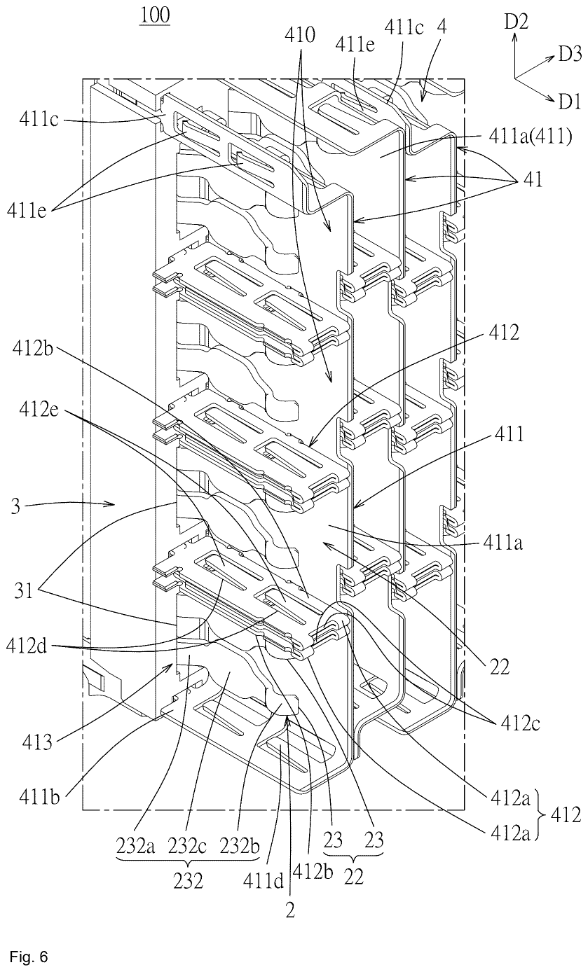

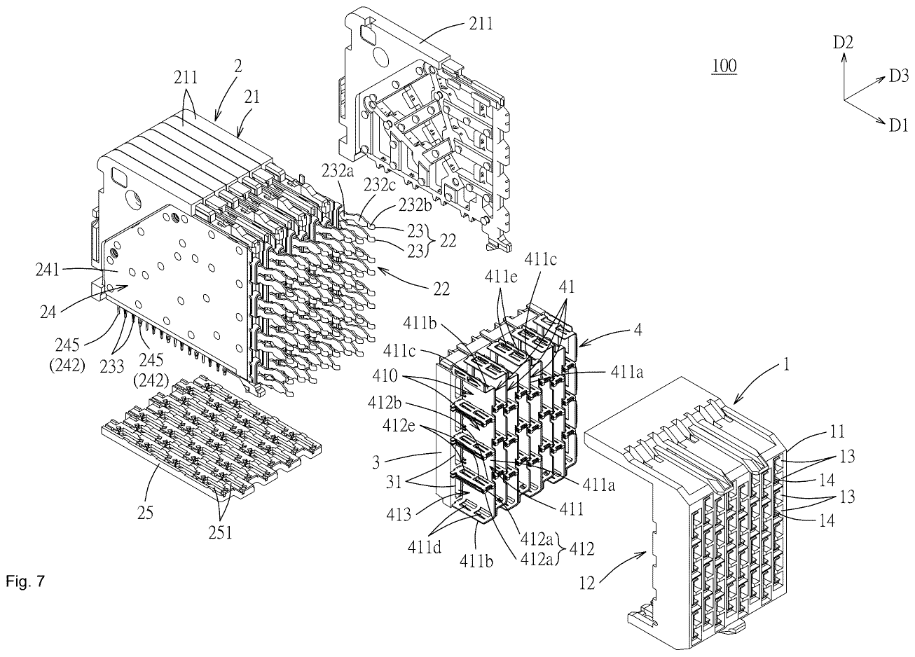

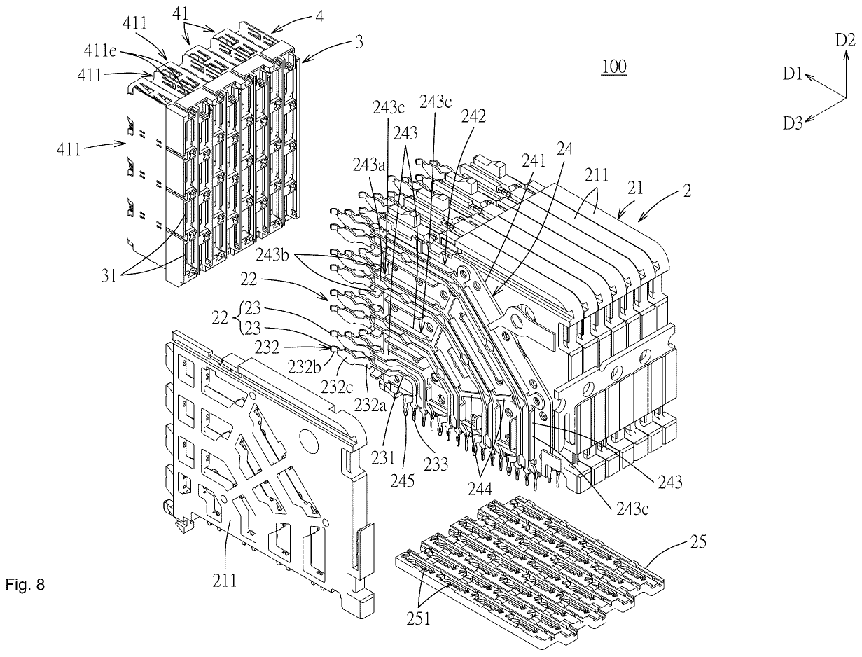

Referring to FIG. 6 to FIG. 8, each signal terminal pair 22 of the terminal module 2 has two signal terminals 23, each signal terminal 23 has a providing segment 231 which is provided in the insulative terminal base 21 and is L-shaped, a mating segment 232 which extends forwardly from the providing segment 231 into the corresponding signal mating port 13 of the housing 1, and a terminal tail 233 which extends downwardly from the providing segment 231. The plurality of terminal shielding members 24 are respectively provided to the plurality of terminal base wafers 211, and the plurality of terminal shielding members 24 respectively correspond to the plurality of signal terminal pairs 22 which are arranged as the rows. Each terminal shielding member 24 includes a shielding plate 241 and a shielding frame 242 which is provided to the shielding plate 241. The shielding frame 242 has multiple terminal shielding structures 243 which respectively correspond to one row of the rows of the signal terminal pairs 22, multiple connecting structures 244 which are connected between the multiple terminal shielding structures 243, and multiple grounding tails 245 which are formed at bottom portions of the multiple terminal shielding structures 243. Each terminal shielding structure 243 has a basic wall 243a and side walls 243b which extend from the basic wall 243a, each terminal shielding structure 243 at least locally forms a U-shaped shielding structure 243c which is constituted together by the basic wall 243a and the side walls 243b and receives at least a part of the providing segment 231 of the corresponding signal terminal pair 22. The U-shaped shielding structures 243c can lower crosstalk among the plurality of signal terminal pairs 22 to promote signal integrity.

The insulative bottom base 25 is provided to the bottom of the insulative terminal base 21, and the insulative bottom base 25 is formed with a plurality of through holes 251, the terminal tails 233 of the signal terminals 23 and the grounding tails 245of the shielding frames 242 of the plurality of terminal shielding members 24 pass through the plurality of through holes 251 respectively and extend downwardly, so as to snap into and be mounted on a circuit board (not shown).

The grounding conductor 3 is provided to a front portion of the insulative terminal base 21 of the terminal module 2, and is received in the assembling groove 12 of the housing 1. The grounding conductor 3 has a plurality of passageways 31 which are penetratingly formed front and rear and respectively correspond to the plurality of signal terminal pairs 22. A material of the grounding conductor 3 for example may be a conductive plastic, but the present disclosure is not limited thereto.

The shielding assembly 4 is provided to a front portion of the grounding conductor 3, and includes a plurality of shielding structures rows 41 which are staggeringly arranged side by side along the left-right direction D3, in the first embodiment, the plurality of signal terminal pairs 22 also are staggeringly arranged side by side corresponding to the plurality of shielding structures rows 41 which are staggeringly arranged side by side. It is noted that, in other implement manners, the plurality of shielding structures rows 41 and the plurality of signal terminal pairs 22 also may not be staggeringly arranged side by side but may be aligned side by side with each other, so the present disclosure is not limited to the first embodiment. Each shielding structure row 41 includes a ground shielding plate 411 which extends along the up-down direction D2, multiple partitioning plate components 412 which are spaced apart from each other and arranged side by side along the up-down direction D2 and are provided to the ground shielding plate 411, and multiple mating slots 413 which are defined together by the ground shielding plate 411 and the multiple partitioning plate components 412. Specifically, the ground shielding plate 411 and the multiple partitioning plate components 412 are provided to the grounding conductor 3 by insertion with interference fit, and the multiple partitioning plate components 412 also are provided to the ground shielding plate 411 by insertion with interference fit, in comparison with assembling by welding, the multiple partitioning plate components 412 and the ground shielding plate 411 are simple and more convenient in assembling, but the present disclosure is not limited thereto.

The ground shielding plate 411 has a shielding plate body 411a which allows the multiple partitioning plate components 412 to be provided thereon, two side plate bodies 411b which bend from two side edges of the shielding plate body 411a respectively and extend, and are spaced apart from and arranged side by side with the multiple partitioning plate components 412, and a contact plate body 411c which bends from one of the two side plate bodies 411b and extends outwardly. Each side plate body 411b has two ground elastic pieces 411d which protrude toward the adjacent mating slot 413 and are arranged along the front-rear direction D1. The contact plate body 411c has two contact elastic pieces 411e which are arranged along the front-rear direction D1, the contact elastic piece 411e contacts the shielding plate body 411a of the ground shielding plate 411 of the adjacent shielding structure row 41, so that the ground shielding plates 411 of the plurality of shielding structures rows 41 are connected in series.

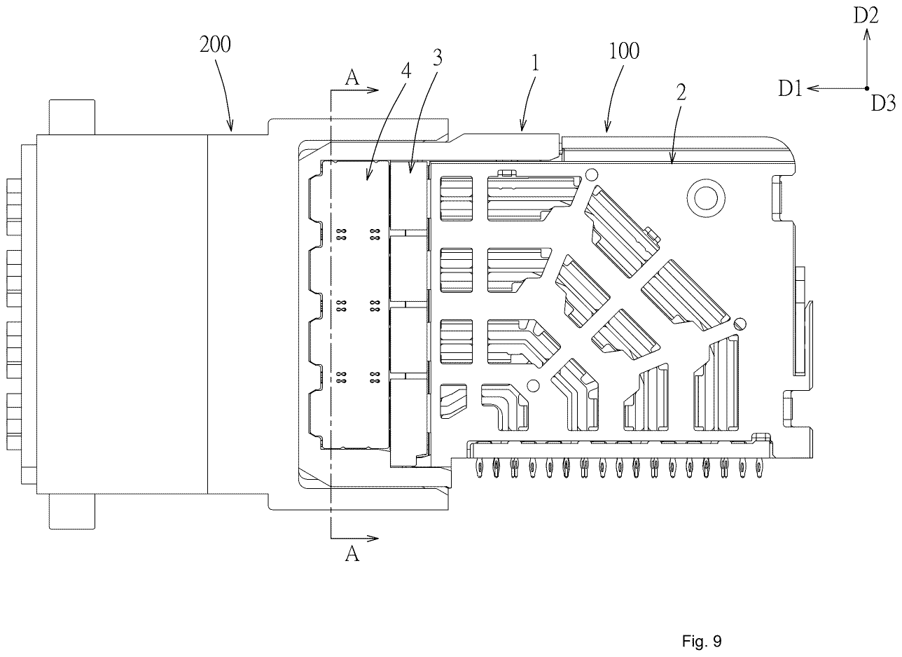

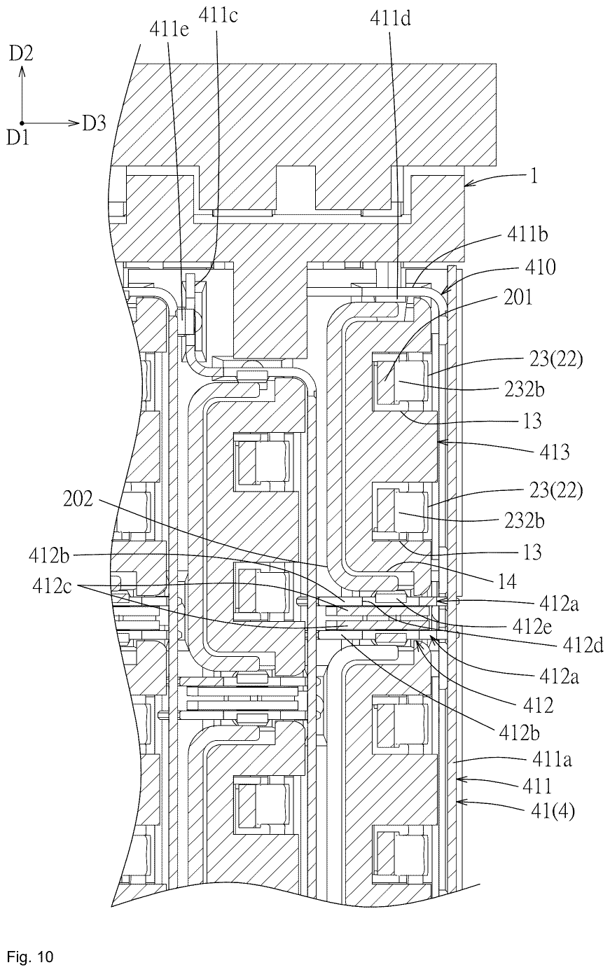

Referring to FIG. 6, FIG. 9 and FIG. 10, each partitioning plate component 412 has two partitioning plates 412a which are spaced apart from each other and arranged side by side along the up-down direction D2. Each partitioning plate 412a has a first plate portion 412b, and a second plate portion 412c which is bent from and connected to the first plate portion 412b, and is away from the adjacent mating slot 413 relative to the first plate portion 412b. The first plate portion 412b has two openings 412d which are arranged along the front-rear direction D1, and two ground elastic pieces 412e which are arranged along the front-rear direction D1 and are respectively formed at edges of the two openings 412d, the second plate portion 412c blocks the two openings 412d of the first plate portion 412b. The two ground elastic pieces 412e protrude toward the adjacent mating slot 413. Because the second plate portion 412c blocks the two openings 412d of the first plate portion 412b, crosstalk between the signal terminal pairs 22 can be reduced, signal integrity is increased, but it is noted that, in other implement manners, the second plate portion 412c also may be omitted, so the present disclosure is not limited to the first embodiment. In addition, it is also noted that, although that the ground elastic piece 411d of each side plate body 411b and the contact elastic piece 411e of the first plate portion 412b in the ground shielding plate 411 and the ground elastic piece 412e of the partitioning plate component 412 each are two in number can increase the number of contact points to promote signal integrity, in other embodiments, the ground elastic piece 411d of each side plate body 411b and the contact elastic piece 411e of the first plate portion 412b in the ground shielding plate 411 and the ground elastic piece 412e of the partitioning plate component 412 each may be only one, so the present disclosure is not limited to the first embodiment.

The plurality of signal terminal pairs 22 of the terminal module 2 respectively extend into the mating slots 413. The mating segments 232 of the two signal terminals 23 of each signal terminal pair 22 forwardly pass through the corresponding passageway 31 without contacting the grounding conductor 3, to extend into the corresponding mating slot 413. The mating segment 232 of each signal terminal 23 has a passing portion 232a which passes through the passageway 31, a contacting portion 232b which is used for mating, and a wide enlarged portion 232c which is positioned between the passing portion 232a and the contacting portion 232b and has a width larger than the contacting portion 232b. The wide enlarged portion 232c can increase structure strength of the signal terminal 23 and can reduce impedance to increase signal integrity.

Because the multiple mating slots 413 arranged in the up-down direction D2 is defined by the same the ground shielding plate 411, each mating slot 413 arranged in the up-down direction D2 can attain good equipotential effect in ground shielding. In addition, the contact elastic pieces 411e of the contact plate bodies 411c of the ground shielding plates 411 further can connect the ground shielding plates 411 of the plurality of shielding structures rows 41 in series, so that all the mating slots 413 attain good equipotential effect in ground shielding. Thus, complete shielding effect is attained to lower crosstalk, so as to maintain signal integrity of the connector 100. In addition, in other words, each shielding structure row 41 includes multiple shielding structures 410 which correspond to the signal terminal pairs 22, each shielding structure 410 includes a basic plate (a part of the shielding plate body 411a of the ground shielding plate 411) and two side plates (the partitioning plate components 412 or the partitioning plate component 412 and the side plate body 411b of the ground shielding plate 411) which are provided to the front portion of the grounding conductor 3, and the mating slot 413 which is defined together by the basic plate and the two side plates. The grounding conductor 3 and the multiple shielding structures 410 of the shielding assembly 4 provided to the grounding conductor 3 respectively can surround and shelter the respective signal terminal pairs 22 from three sides. It is noted that, the signal terminal pair 22 between the two adjacent shielding structure rows 41 may be surrounded and sheltered from four sides.

Referring to FIG. 3, FIG. 6, FIG. 9 and FIG. 10, when the connector 100 and the counterpart connector 200 mate with each other, a plurality of counterpart signal terminal pairs 201 of the counterpart connector 200 respectively insert into the plurality of signal mating ports 13 of the housing 1 to respectively contact the contacting portions 232b of the plurality of signal terminal pairs 22 of the connector 100. And, a plurality of counterpart grounding cages 202 (see FIG. 3) of the counterpart connector 200 which each have a cross section in form of U-shaped construction respectively insert into the plurality of ground mating ports 14 of the housing 1 to contact the respective ground elastic pieces 411d, 412e of the shielding assembly 4. Wherein, each counterpart grounding cage 202 shelters the corresponding counterpart signal terminal pair 201, the shielding structure 410 of the connector 100 and the counterpart grounding cage 202 which contact each other can together surround and shelter the signal terminals pair 22 and the counterpart signal terminal pair 201, which mate with each other, from four sides, so complete shielding effect can be attained to lower crosstalk so as to maintain signal integrity of the connector 100.

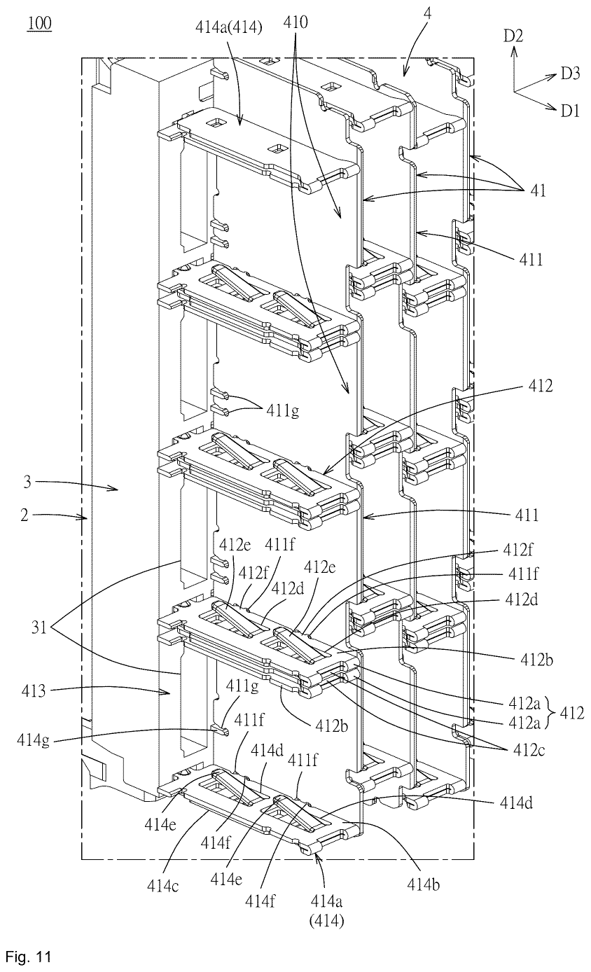

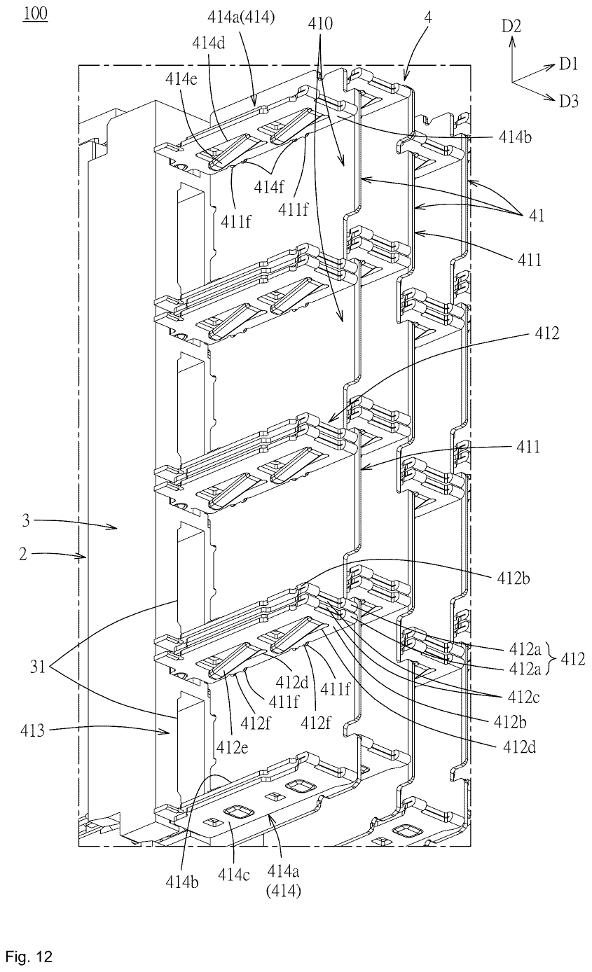

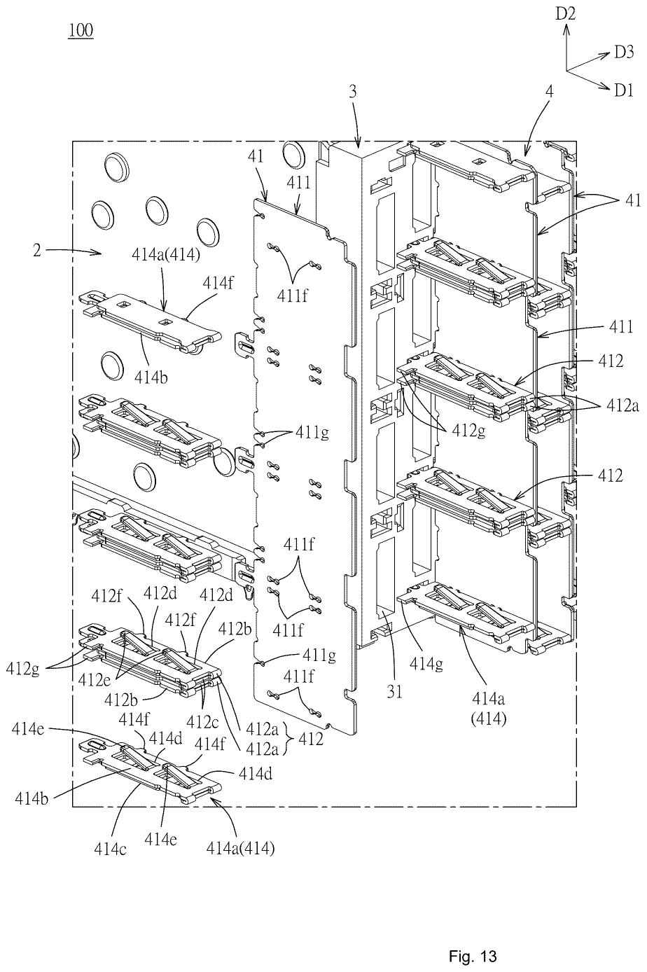

Referring to FIG. 11 to FIG. 13, a second embodiment of the connector 100 of the present disclosure differs from the first embodiment in that, each shielding structure row 41 further includes two side partitioning plate components 414 which are respectively provided to two side portions of the ground shielding plate 411 and are spaced apart from and arranged side by side with the multiple partitioning plate components 412. Each side partitioning plate component 414 has a side plate 414a. Similar to the partitioning plate 412a in structure, each side plate 414a has a first plate portion 414b, and a second plate portion 414c which is bent from and connected to the first plate portion 414b and is away from the adjacent mating slot 413 relative to the first plate portion 414b. The first plate portion 414b has two openings 414d which are arranged along the front-rear direction D1, and two ground elastic pieces 414e which are arranged along the front-rear direction D1 and are respectively formed at edges of the two openings 414d, the second plate portion 414c blocks the two openings 414d of the first plate portion 414b. The two ground elastic pieces 414e protrude toward the adjacent mating slot 413. Because the second plate portion 414c blocks the two openings 414d of the first plate portion 414b, crosstalk can be reduced, signal integrity is increased.

In addition, similar to the first embodiment, in the second embodiment, the multiple partitioning plate components 412 of the shielding structure row 41 are further connected to the ground shielding plate 411 of the adjacent shielding structure row 41, so that the two adjacent ground shielding plates 411 are connected in series. Wherein, the ground shielding plate 411 of each shielding structure row 41 has a multitude of first providing holes 411f and a multitude of second providing holes 411g, each partitioning plate component 412 further has first providing protrusions 412f which extend from the first plate portions 412b of the two partitioning plates 412a and are used to be respectively provided in the first providing holes 411f of the ground shielding plate 411 with interference fit, and second providing protrusions 412g which extend from the first plate portions 412b of the two partitioning plates 412a and are used to be respectively provided in the second providing holes 411g of the ground shielding plate 411 of the adjacent shielding structure row 41 with interference fit. Similarly, the two side partitioning plate components 414 of the shielding structure row 41 are further connected to the ground shielding plate 411 of the adjacent shielding structure row 41, so that the two adjacent ground shielding plates 411 are connected in series. Each side partitioning plate component 414 further has two first providing protrusions 414f which extend from the first plate portion 414b of the side plate 414a and are used to be respectively provided in the two first providing holes 411f of the ground shielding plate 411with interference fit, and a second providing protrusion 414g which extends from the first plate portion 414b of the side plate 414a and is used to be provided in the second providing hole 411g of the ground shielding plate 411 of the adjacent shielding structure row 41 with interference fit. By the partitioning plate components 412 and the side partitioning plate components 414, the ground shielding plates 411 of the plurality of shielding structure rows 41 can be connected in series.

In addition, in other words, in the second embodiment, each shielding structure row 41 includes multiple shielding structures 410, each shielding structure 410 includes a basic plate (the ground shielding plate 411) and two side plates (the partitioning plate components 412 or the side partitioning plate component 414 and the partitioning plate component 412) which are provided to the front portion of the grounding conductor 3, and the mating slot 413 which are defined together by the basic plate and the two side plates.

In conclusion, in the connector 100 of the present disclosure, the grounding conductor 3 and the multiple shielding structures 410 of the shielding assembly 4 provided to the grounding conductor 3 can shelter the respective signal terminal pairs 22; in addition, the ground shielding plate 411 of the shielding assembly 4 and the multiple partitioning plate components 412 can together define the multiple mating slots 413 which receive the respective signal terminal pairs 22, because the multiple mating slots 413 are defined by the same the ground shielding plate 411, each mating slot 413 can attain good equipotential effect in ground shielding. Thus, complete shielding effect is attained to lower crosstalk so as to maintain signal integrity of the connector 100.

However, the above description is only for the embodiments of the present disclosure, and it is not intended to limit the implementing scope of the present disclosure, and the simple equivalent changes and modifications made according to the claims and the contents of the specification of the present disclosure still belong to the scope of the present disclosure.

### LIST OF REFERENCE NUMERALS

100 connector
1 housing
11 mating portion
12 assembling groove
13 signal mating port
14 ground mating port
2 terminal module
21 insulative terminal base
211 terminal base wafer
22 signal terminal pair
23 signal terminal
231 providing segment
232 mating segment
232a passing portion
232b contacting portion
232c wide enlarged portion
233 terminal tail
24 terminal shielding member
241 shielding plate
242 shielding frame
243 terminal shielding structure
243a basic wall
243b side wall
243c U-shaped shielding structure
244 connecting structure
245 grounding tail
25 insulative bottom base
251 through hole
3 grounding conductor
31 passageway
4 shielding assembly
41 shielding structure row
410 shielding structure
411 ground shielding plate
411a shielding plate body
411b side plate body
411c contact plate body
411d ground elastic piece
411e contact elastic piece
411f first providing hole
411g second providing hole
412 partitioning plate component
412a partitioning plate
412b first plate portion
412c second plate portion
412d opening
412e ground elastic piece
412f first providing protrusion
412g second providing protrusion
413 mating slot
414 side partitioning plate component
414a side plate
414b first plate portion
414c second plate portion
414d opening
414e ground elastic piece
414f first providing protrusion
414g second providing protrusion
200 counterpart connector
201 counterpart signal terminal pair
202 counterpart grounding cage
D1 front-rear direction
D2 up-down direction
D3 left-right direction

What is claimed is:

1. A connector, comprising:
a terminal module comprising an insulative terminal base and a plurality of signal terminal pairs provided to the insulative terminal base, a grounding conductor provided to a front portion of the insulative terminal base of the terminal module, the grounding conductor having a plurality of passageways which is penetratingly formed front and rear and respectively correspond to the plurality of signal terminal pairs; and
a shielding assembly provided to the grounding conductor, the shielding assembly comprising a plurality of shielding structures which correspond to the plurality of signal terminal pairs, each shielding structure comprising a basic plate and two side plates which are provided to a front portion of the grounding conductor, and a mating slot which is defined together by the basic plate and the two side plates, the mating slot being positioned in front of the corresponding passageway and being communicated with the passageway, each signal terminal pair forwardly passing through the corresponding passageway without contacting the grounding conductor, to extend into the mating slot, each side plate having a ground elastic piece which protrudes toward the mating slot.

2. The connector of claim 1, wherein a material of the grounding conductor is a conductive plastic.

3. The connector of claim 1, wherein each side plate has the two ground elastic pieces which are arranged front and rear.

4. The connector of claim 1, wherein
each signal terminal pair of the terminal module has two signal terminals,
each signal terminal has a passing portion which passes through the passageway, a contacting portion which is used for mating, and a wide enlarged portion which is positioned between the passing portion and the contacting portion and has a width larger than the contacting portion.

5. A connector, comprising:
a shielding assembly comprising a shielding structure row, the shielding structure row comprising a ground shielding plate, multiple partitioning plate components which are spaced apart from each other and arranged side by side and are provided to the ground shielding plate, and multiple mating slots which are defined together by the ground shielding plate and the multiple partitioning plate components; and
a terminal module comprising a plurality of signal terminal pairs, the plurality of signal terminal pairs correspondingly extend into the multiple mating slots.

6. The connector of claim 5, wherein
each partitioning plate component has two partitioning plates which are spaced apart from each other and arranged side by side,
each partitioning plate has a ground elastic piece which protrudes toward the adjacent mating slot.

7. The connector of claim 6, wherein
each partitioning plate further has a first plate portion and a second plate portion which is bent from and connected to the first plate portion and is away from the adjacent mating slot relative to the first plate portion,
the first plate portion has an opening and the ground elastic piece which is formed at an edge of the opening,
the second plate portion blocks the opening of the first plate portion.

8. The connector of claim 5, wherein
the ground shielding plate has a shielding plate body which allows the multiple partitioning plate components to be provided thereon, and two side plate bodies which bend from two side edges of the shielding plate body respectively and extend, and are spaced apart from and arranged side by side with the multiple partitioning plate components, each side plate body has a ground elastic piece which protrudes toward the adjacent mating slot.

9. The connector of claim 8, wherein
the shielding assembly comprises the plurality of shielding structure rows which are staggeringly arranged side by side,
the ground shielding plate of each shielding structure row further has a contact plate body which bends from one of the two side plate bodies and extends outwardly, the contact plate body has a contact elastic piece which contacts the shielding plate body of the ground shielding plate of the adjacent shielding structure row.

10. The connector of claim 5, wherein
the terminal module further comprises an insulative terminal base, the plurality of signal terminal pairs are provided to the insulative terminal base,
the connector further comprises a grounding conductor, the grounding conductor is provided to a front portion of the insulative terminal base of the terminal module, and the shielding assembly is provided to a front portion of the grounding conductor, the grounding conductor has a plurality of passageways which is penetratingly formed front and rear and respectively correspond to the plurality of signal terminal pairs, each signal terminal pair forwardly passes through the corresponding passageway without contacting the grounding conductor, to extend into the mating slot.

11. The connector of claim 10, wherein
each signal terminal pair of the terminal module has two signal terminals,
each signal terminal has a passing portion which passes through the passageway, a contacting portion which is used for mating, and a wide enlarged portion which is positioned between the passing portion and the contacting portion and has a width larger than the contacting portion.

12. The connector of claim 5, wherein
the terminal module further comprises an insulative terminal base and a plurality of terminal shielding structures,
the plurality of signal terminal pairs are provided to the insulative terminal base,
the plurality of terminal shielding structures respectively correspond to the plurality of signal terminal pairs,
each terminal shielding structure has a basic wall and side walls which extend from the basic wall, each terminal shielding structure at least locally forms a U-shaped shielding structure which is constituted together by the basic wall and the side walls and receives the corresponding signal terminal pair.

13. The connector of claim 12, wherein
the terminal module further comprises a plurality of terminal shielding members, the plurality of signal terminal pairs are arranged as rows and are provided to the insulative terminal base,
the plurality of terminal shielding members are provided to the insulative terminal base and respectively correspond to the plurality of signal terminal pairs arranged as the rows,
each terminal shielding member comprises a shielding plate and a shielding frame which is provided to the shielding plate and is formed with the terminal shielding structures.

14. The connector of claim 5, wherein
the shielding assembly includes the plurality of shielding structure rows which are arranged side by side,
the multiple partitioning plate components of each shielding structure row are further connected to the ground shielding plate of the adjacent shielding structure row, so that the two adjacent ground shielding plates are connected in series.

15. The connector of claim 14, wherein
the ground shielding plate of each shielding structure row has a multitude of first providing holes and a multitude of second providing holes,
each partitioning plate component has a first providing protrusion which is used to be provided in the corresponding first providing hole of the ground shielding plate, and a second providing protrusion which is used to be provided in the corresponding second providing hole of the ground shielding plate of the adjacent shielding structure row.

16. The connector of claim 5, wherein
the shielding structure row further includes two side partitioning plate components which are respectively provided to two side portions of the ground shielding plate and are spaced apart from and arranged side by side with the multiple partitioning plate components,
each side partitioning plate component has a ground elastic piece which protrudes toward the adjacent mating slot.

17. The connector of claim 16, wherein
each side partitioning plate component has a side plate,
the side plate has a first plate portion and a second plate portion which is bent from and connected to the first plate portion and is away from the adjacent mating slot relative to the first plate portion,
the first plate portion has an opening and the ground elastic piece which is formed at an edge of the opening,
the second plate portion blocks the opening of the first plate portion.

18. The connector of claim 16, wherein
each partitioning plate component has two partitioning plates which are spaced apart from each other and arranged side by side, each partitioning plate has a ground elastic piece which protrudes toward the adjacent mating slot;
each side partitioning plate component has a side plate, the side plate has the ground elastic piece which protrudes toward the adjacent mating slot.

19. The connector of claim 16, wherein
the shielding assembly includes the plurality of shielding structure rows which are arranged side by side,
the two side partitioning plate components of each shielding structure row are further connected to the ground shielding plate of the adjacent shielding structure row, so that the two adjacent ground shielding plates are connected in series.

20. The connector of claim 19, wherein
the ground shielding plate of each shielding structure row has a multitude of first providing holes and a multitude of second providing holes,
each side partitioning plate component has a first providing protrusion which is used to be provided in the corresponding first providing hole of the ground shielding plate, and a second providing protrusion which is used to be provided in the corresponding second providing hole of the ground shielding plate of the adjacent shielding structure row.
